(19) United States
(12) Patent Application Publication
(10) Pub. No.: US 2022/0194842 A1
(43) Pub. Date: Jun. 23, 2022

(54) WASTE GLASS RECOVERY METHOD FOR MANUFACTURING GLASS BEAD

(71) Applicant: Yong Su LEE, Seoul (KR)

(72) Inventor: Yong Su LEE, Seoul (KR)

(21) Appl. No.: 17/132,886

(22) Filed: Dec. 23, 2020

(51) Int. Cl. C03C 1/00; C03C 12/02; C09D 5/33; B32B 43/00; B09B 3/00; B08B 7/00

(52) U.S. Cl. CPC C03C 1/002; C03C 12/02; C09D 5/004; B32B 43/006; B32B 2457/12; B08B 7/0071; B32B 2305/70; B32B 2309/02; B32B 2315/08; B09B 3/0083

(57) ABSTRACT

The present invention particularly relates to a waste glass recovery method for manufacturing glass beads for road markings, and more particularly, to a waste glass recovery method for manufacturing glass beads which includes recovering waste glass such as automobile waste glass, solar panel waste glass, and general cullet, classifying and removing impurities contained in the glass.

### TECHNICAL FIELD

The present invention particularly relates to a waste glass recovery method for manufacturing glass beads for road markings, and more particularly, to a waste glass recovery method for manufacturing glass beads which includes recovering waste glass such as automobile waste glass, solar panel waste glass, and general cullet, classifying and removing impurities contained in the glass.

### BACKGROUND

In general, glass beads for road markings are mixed with paint for traffic lanes to be applied, or scattered before curing immediately after the paint for traffic lanes is applied on the road, so that the glass beads can reflect light to help drivers to clearly see the traffic lanes at night or in rain.

An example of the related art of an apparatus for manufacturing such glass beads, Korean Patent No. 10-0232478 discloses an apparatus including a top main body and a bottom heating part, wherein several gas burners and material (glass powder) input ports are installed in the bottom heating part. The glass powder input into the material input ports rises toward the main body and is melted at a high temperature of about 1,000° C. to 1,100° C. by the strong flame of the gas burners, and becomes beads. After becoming the beads, they fall to the discharge part formed in the outer lower part of the main body to be collected.

As described above, glass beads are manufactured using glass, and recently, a manufacture method using waste glass has been proposed to recycle resources. In general, as the waste glass contains various additives (impurities) therein depending on its purpose of use, different methods must be used to separate and recover such waste glass. The waste glass may be largely classified into automobile waste glass, solar panel waste glass, and other cullet.

For example, glass used for solar panels, that is, solar cells using solar panels, is generally formed in a sandwich structure of tempered glass/sealing agent (EVA)/cell (silicon)/sealing agent (EVA)/back sheet. Ethylene vinyl acetate (EVA) is used as the interlayer sealing agent.

In order to recycle solar cells of this structure, it is economical to completely separate each layer by removing the EVA component used as a sealing agent. Related technologies include organic solvent method, nitric acid method, pyrolysis method, and fluidized bed combustion method.

As related art to which the organic solvent method is applied, Korean Patent Publication No. 10-2011-0031688 and Korean Patent Publication No. 10-2012-0000148 are disclosed.

However, the organic solvent method and nitric acid method require long-term treatments of 10 to 20 days, and 25 hours, respectively, and the process waste liquid generated during the process is secondary environmental pollutants, and there is also a problem that the recovered solar cell is damaged by a swelling (bulging) phenomenon of the EVA during the separation.

In addition, the pyrolysis method and the fluidized bed combustion method require high temperature conditions of 520° C., and 450° C. or higher, respectively. Thus, harmful gases such as NOx are generated during the process, and the sealing agent (EVA) surrounding the solar cell is thermally decomposed at a temperature of 450 or higher in an air-tight space of the glass/sealing agent (EVA)/cell to generate CO, CO₂ and VOCs gases. The generated gas is ejected toward a relatively weak cell and at the same time, the cell is damaged.

Therefore, nowadays, there is an increasing need for a more efficient recovery method suitable for each use.

### SUMMARY

Therefore, the present disclosure is conceived to solve the above drawbacks.

An objective of the present disclosure is to provide a waste glass recovery method for manufacturing glass beads from waste glass by which the back sheet and the sealing agent of waste glass are removed from the waste glass.

In particular, it is an objective of the present disclosure to provide a waste glass recovery method designed to improve removal efficiency and work efficiency by heating and removing the back sheet and the sealing agent twice at different temperatures.

Further, it is an objective of the present disclosure to provide a waste glass recovery method capable of improving efficiency by removing the back sheet and the sealing agent of the waste glass heat using a direct heating method or an indirect heating method or a combination of these methods.

Another objective is to provide a waste glass recovery method designed to collect waste glass by sorting waste glass into automobile waste glass, solar panel waste glass and other cullet, and recovering waste glass using a method most suitable for each characteristic of them.

Still another objective is to achieve environmental recycling by stably and cost-effectively recovering automobile waste glass and solar panel waste glass, which are ultimately environmentally problematic, and manufacturing glass beads from such wastes.

In order to achieve the aforementioned objectives, a waste glass recovery method according to the present disclosure includes separating back sheet by first heating the waste glass from which a frame has been separated; and removing sealing agent by heating for the second time the waste glass from which the frame has been separated and evaporating the sealing agent in the waste glass.

As described above, the waste glass recovery method according to the present disclosure has the effect of reliably separating and removing EVA and polysilicon through two heat treatments at low and high temperatures during a solar panel waste glass crushing process.

In addition, since glass beads can be manufactured using such wastes, environmental recycling can be expected.

### BRIEF DESCRIPTION OF THE DRAWINGS

FIG. 1 is schematic diagram of a solar panel waste glass recovery unit used in a waste glass recovery method according to the present disclosure.

FIG. 2 is a schematic diagram of a solar panel waste glass recovery unit unsed in a waste glass recovery method according to the present disclosure.

FIG. 3 is a photograph of a heat treatment member used in the solar panel waste glass recovery unit according to the present disclosure.

FIG. 4 is a block diagram of a process for recovering solar panel waste glass of the waste glass recovery method according to the present disclosure.

FIG. 5 is a set of photographs showing a rack used in the solar panel waste glass recovery unit according to the present disclosure.

FIG. 6 is a set of photographs showing waste glass at each separating step of the recovery method according to the present disclosure.

FIG. 7 is an implementation view of a rack used in the solar panel waste glass recovery unit according to the present disclosure.

FIG. 8 is an implementation view of a press used in the solar panel waste glass recovery unit according to the present disclosure.

FIG. 9 is an implementation view of a method for recovering automobile waste glass of the recovery methods according to the present disclosure.

FIG. 10 is a process flowchart of manufacturing glass beads from waste glass recovered by a waste glass recovery method according to the present disclosure.

FIG. 11 is a schematic block diagram of a waste glass recovery method according to the present disclosure.

FIG. 12A is a modified example of the waste glass recovery method according to the present disclosure.

FIG. 12B is a modified example of the waste glass recovery method according to the present disclosure.

### DETAILED DESCRIPTION

Hereinafter, embodiments of the disclosure will be described in detail with reference to the accompanying drawings.

Although the present disclosure may be modified in various forms, specific embodiments (aspects or examples) thereof will be described in detail and illustrated in the drawings. However, this is not intended to limit the present disclosure to a specific form of disclosure, and it should be understood that all changes, equivalents, and substitutes are included in the technical idea and scope of the present disclosure.

In each drawing, the same reference numerals, in particular reference numerals having the same number in tens place and the same number in ones place, or reference numerals having the same number in tens place, the same number in ones place and the same alphabet denote components or members having the same or similar function. Unless otherwise specified, a component or member indicated by each reference numeral in the drawings may be perceived as a member conforming to this standard.

In addition, in each drawing, sizes or thicknesses of components are expressed for convenience of description and may be exaggerated compared to the actual physical sizes or thicknesses, and therefore, the exaggeration of the drawings should not be construed as limiting the scope of protection of the present invention.

The terms used herein are used to merely describe specific embodiments (aspects or examples), but are not intended to limit the disclosure. The singular forms may include the plural forms unless the context clearly indicates otherwise. Herein, it should be understood that the terms “comprise,” “have,” “contain,” “include,” “consist of” and the like are intended to specify the presence of stated features, numbers, steps, actions, components, parts or combinations thereof, but they do not preclude the presence or addition of one or more other features, numbers, steps, actions, components, parts or combinations thereof.

Unless otherwise defined, all terms used herein, including technical or scientific terms, have the same meaning as commonly understood by a person of ordinary skill in the art to which the present invention belongs. Terms as defined in a commonly used dictionary should be interpreted as having a meaning consistent with the meaning in the context of the related technology, and are not to be interpreted as an ideal or excessively formal meaning unless explicitly defined herein.

In general, waste glass used in manufacturing glass beads for road markings from recycled waste glass should have a refractive index of 1.50 to 1.65 and a retroreflective performance of 0.5 to 1.5. Therefore, all kinds of waste glass cannot be used, and kinds of glass that can satisfy the corresponding conditions, that is, general cullet such as glass windows and industrial glass, waste glass for automobiles, and solar panel waste glass should be used. In other words, the examples of the present disclosure are intended to achieve environmental recycling by stably and cost-effectively recovering automobile waste glass and solar panel waste glass, which are ultimately environmentally problematic, and manufacturing glass beads for road markings from such wastes.

To this end, in the waste glass recovery method M of the present disclosure, a cullet recovery unit A1, an automobile waste glass recovery unit A2, and a solar panel waste glass recovery unit A3 are used to recover each kind of waste glass in a most suitable manner.

First, although not shown in the drawing, the cullet recovery unit A1 crushes cullet such as an input glass window or industrial glass to a predetermined particle size using a jaw crusher or a hammer crusher that is generally used, and allows the crushed cullet to be recovered by a glass bead manufacturing unit to be described later, which is a conventionally known technique, and thus a detailed description thereof will be omitted.

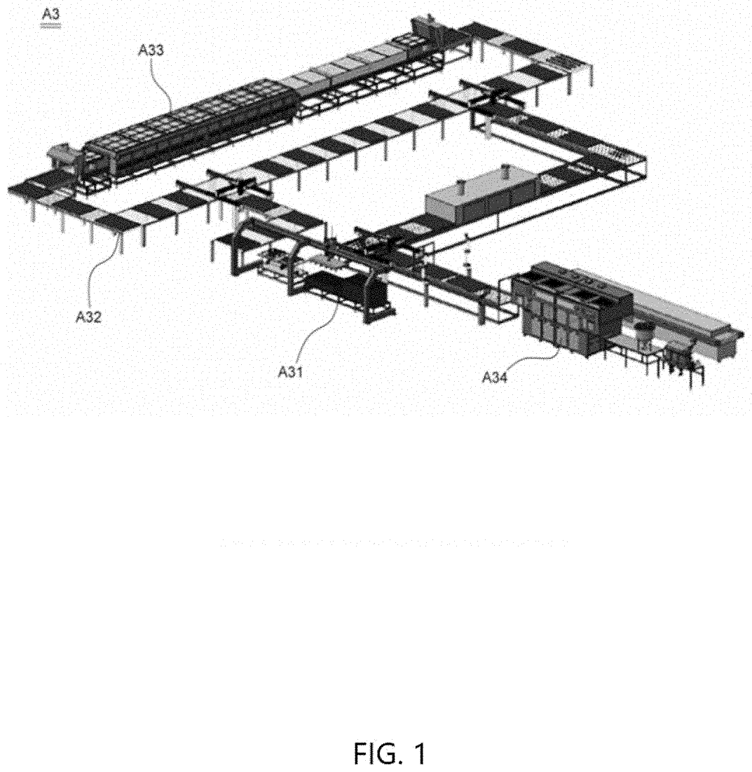

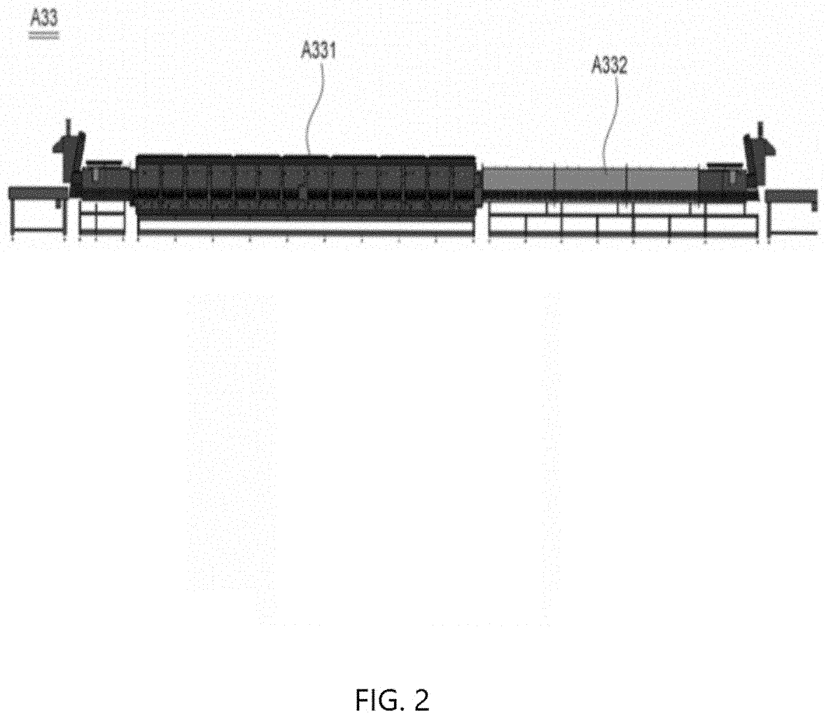

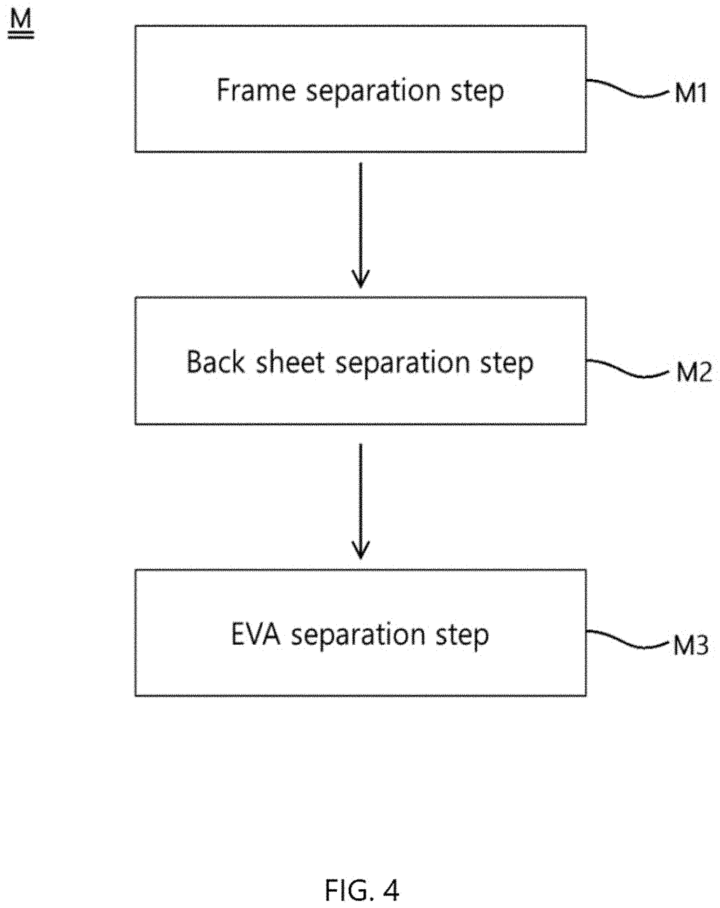

FIGS. 1 and 2 represent a schematic configuration of the solar panel waste glass recovery unit A3, which is arranged spaced apart from the cullet recovery unit and recovers solar panel waste glass of a preset particle size by crushing the input solar panel waste glass G and heating it twice at low and high temperatures through a process that consists of a frame separating step M1, a back sheet separating step M2, and an sealing agent (Ethylene Vinyl Acetate (EVA)) separating step M3 as shown in FIG. 4.

Referring to FIGS. 1, 2 and 4, each process will be described in detail in connection with the configuration of the solar panel waste glass recovery unit A3. First, a frame removal part A31 is provided for removing a frame GF attached to the solar panel waste glass.

The frame removal part A31 separates the frame GF made of aluminum (Al) attached to the solar panel waste glass stacked in a plurality of layers, more precisely, to a photovoltaic (PV) panel.

The waste glass G from which the frame GF has been removed in the frame removal part A31 is transferred to a heating part A33 through a conveyor part A32.

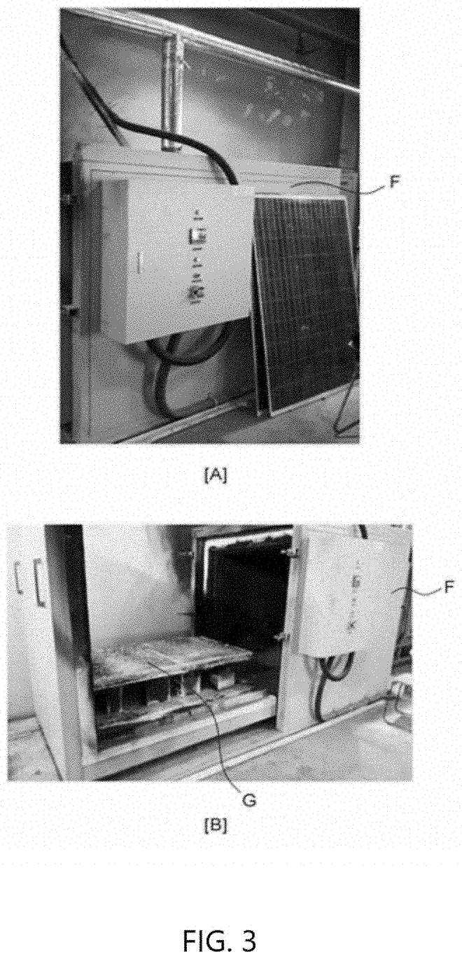

The heating part A33 is provided with a heating member F which applies heat to the waste glass G introduced thereinto. The heating member F is formed with a furnace as shown in FIG. 3, which may include, but is not limited to, any one of a vacuum furnace, a nitrogen/argon furnace, and a general furnace.

According to the present disclosure, it is characterized to stepwisely remove the back sheet BS and the sealing agent EVA included in the waste glass G by heating them to different temperatures, and thus, for this purpose, it is preferable that the heating part A33 is provided with two heating members F. However, it is also possible for an operator to set different temperatures using one heat member F. So, it should be noted that such example is not intended to limit the scope of the present disclosure.

In the drawings, an example is shown where the heating part A33 is formed with a first heating part A331 and a second heating part A332 which are provided with the heating members F, respectively, for convenient operation.

The process of the present disclosure proceeds to a step M2 of separating the back sheet BS through the first heating part A331, and then to a step M3 of heating the waste glass G a second time through the second heating part A332 to evaporate and remove the sealing agent.

More specifically, the first heating part A331 removes the back sheet attached to the solar panel waste glass by applying heat of a preset low temperature to the solar panel waste glass.

The low temperature heat applied from the first heating part is set to 100-250° C. in order to accomplish effective removal of back sheet adhesive. Since the adhesive used for the back sheet is a highly durable polymer adhesive such as two package type polyurethane adhesive, it would be difficult to separate the back sheet in the first heating member unless its adhesive strength is lowered by high temperature. Therefore, even though it may vary depending on the aging degree of the solar panel waste glass, the temperature of the first heating part should be kept at a temperature equal to or higher than 100□ in order to reduce the adhesive strength of the adhesive used for the back sheet within a short period of time. Further, in a case of a composite adhesive that is resistant to change in temperature and to hydrolysis, its separation would be possible at a temperature equal to or higher than 200° C.

Furthermore, for convenient separation of the back sheet, it is required to melt only the adhesive on the back sheet without EVA (Ethylene Vinyl Acetate) being ignited, carbonized or cured, and the ignition point of EVA is 260° C. Accordingly, it is preferable that the low temperature heat applied from the first heating part is set to 100 to 250° C.

In order to more effectively separate the back sheet BS in the first heating part A331, a direct heating method using a press P equipped with a heating wire PL may be used, or an indirect heating method using infrared or a hot air blower may be used. Alternatively, it is preferable to shorten the time of the heat treatment by mixing and using two or more of these methods together.

Specifically, in order to minimize the heat loss of the heating member F, the temperature of the back sheet is increased as high as possible by using the press P equipped with the heating wire PL, and then the waste glass is put into the furnace. At this time, in order to prevent the back sheet from sticking to the press, it is preferable that the heating wire provided in the press is set to a temperature of 100 to 250° C., which is a temperature capable of lowering its adhesive force as much as possible (It is the same as a press which is used in the second heating part, and will be described in more detail below).

Secondly, the infrared heating method is used to quickly heat only the rear surface of the solar panel while decreasing the adhesive strength of the back sheet, so that the back sheet can be easily separated. Although the set value may vary depending on the kind of back sheet, adhesive, or aspect of EVA, it is preferable to heat for 30 to 300 seconds so that the surface temperature of the back sheet is 100 to 250° C.

Finally, the method of using a hot air blower is to apply hot air to the back sheet in a closed facility until the temperature is also heated to 100 to 250° C. At this time, the hot air is set to be applied directly only to the back sheet to preferentially heat the adhesive, thus minimizing heat loss of the furnace.

The second heating part A332 applies high-temperature heat to the waste glass from which the back sheet has been removed in the first heating part, to remove the sealing agent (EVA) and the cell (silicon) attached thereto.

The temperature of the heat applied by the second heating part A332 is set to 350-700° C.

As shown in Table 1, the evaporation point of EVA, which is the most important component to be treated through the second heating part, is about 300 to 350° C., and the temperature at which the weight is completely reduced is about 550° C. Even though the initial temperature at which the weight begins to decrease is around 350° C., and the temperature at which the weight has been completely reduced is around 550° C. according to Table 1, it is preferable that the high temperature heat applied from the second heating part is set to 350 to 700° C. by adding a margin of 150° C. to ensure a stable process in practice.

Furthermore, in order to prevent heat loss of the heating member F in the second heating part A332, a direct heating method using a rack provided with a heating wire PL and into which the waste glass is inserted, or the press P equipped with a heating wire PL to heat the waste glass directly may be used, or an indirect heating method using infrared or a hot air blower may be used. Alternatively, two or more of these methods may be mixed or used together.

Specifically, in a case of heating the waste glass to a temperature of 350-700° C. using the heating member after fastening the waste glass to the rack capable of applying heat by transferring heat energy to the waste glass with the heating wire or other method, energy loss can be minimized since direct heat transfer to the waste glass through the rack is carried out in parallel. Also, a large number of waste glasses can be subjected to the process together, since they can be stacked in multiple layers on the racks, respectively in the heating member. Additionally, since the rack firmly secures the waste glass, it is possible to prevent the waste glass from the damage caused by EVA evaporation shock or thermal shock.

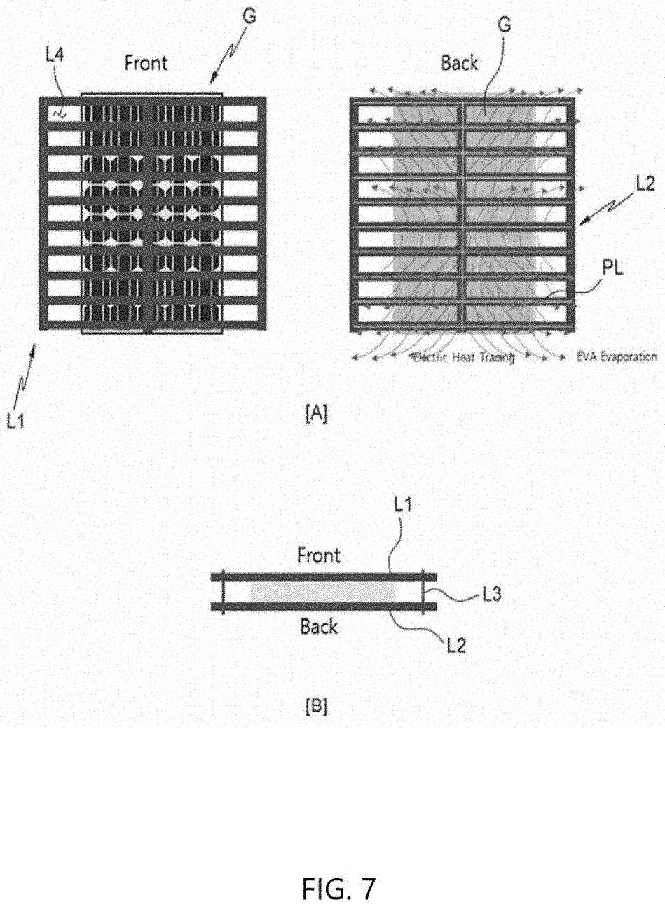

The rack L is a lattice-like net in which a plurality of pores L4 are formed, as shown in FIG. 7, and may be formed with an top rack L1, a bottom rack L2, and a connecting bar L3 connecting the upper rack L1 and the bottom rack L2. The top rack L1 or the bottom rack L2, or both are provided with the heating wire PL which directly transfers heat to the waste glass G, thereby increasing work efficiency.

Particularly, for complete recovery of the waste glass, the pores L4 are formed to prevent the waste glass from the damage caused by the pressure of the evaporated EVA, and also to enable effective thermal circulation.

In addition, after being coupled to the rack L, the treatment time through the heating member is preferably set within 0.5 to 5 hours.

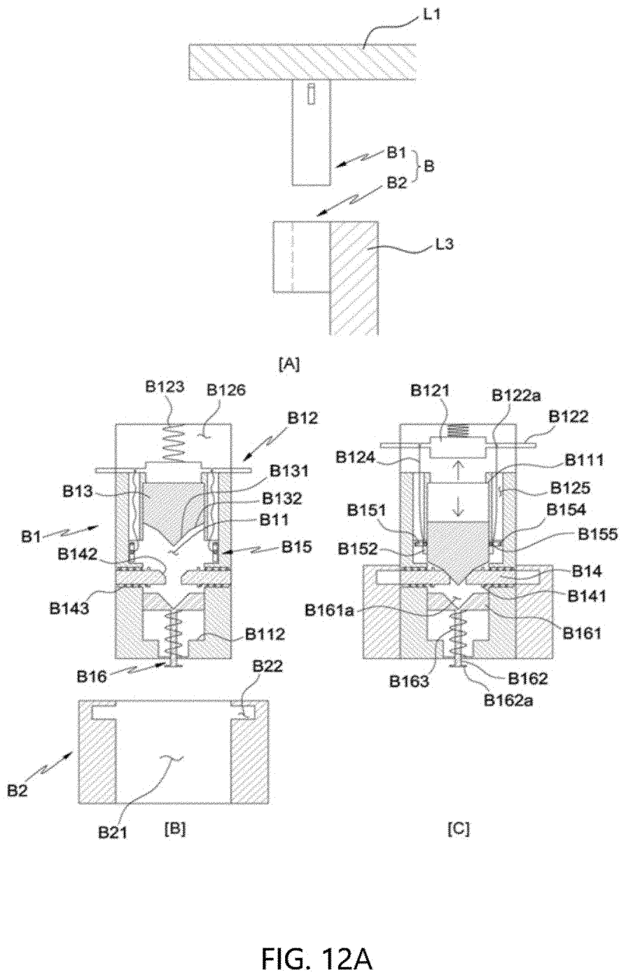

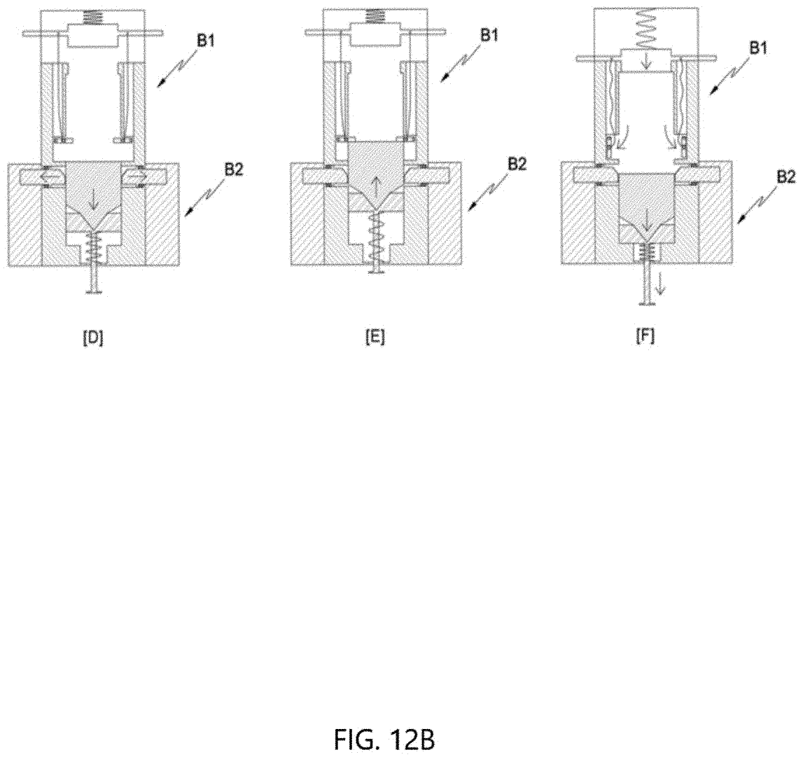

Furthermore, fixed connection between the top rack L1 and the connecting bar L3, and fixed connection between the bottom rack L2 and the connecting bar can be easily and releasably made by a fixing block unit B, which will be described in more detail below with reference to FIGS. 12a and 12b.

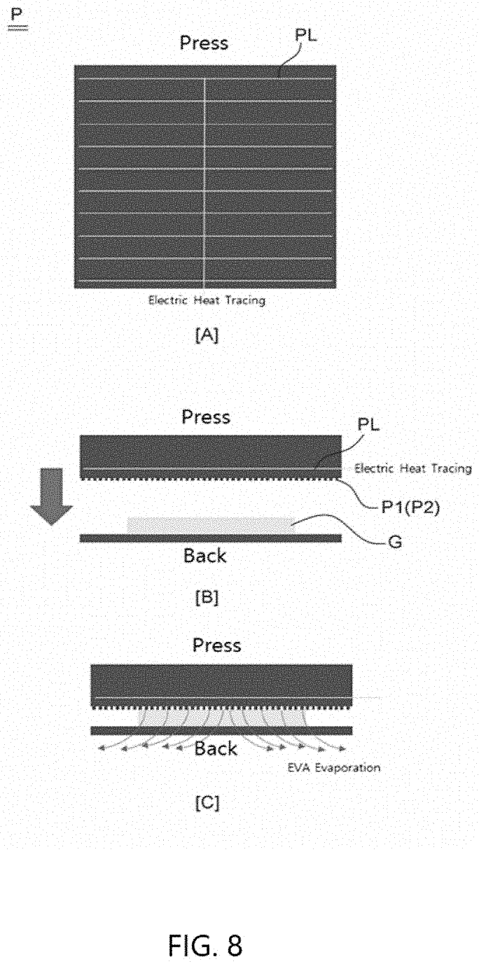

Furthermore, as another direct heating method, heat is directly transferred to the waste glass from a press (P) equipped with a heating wire as previously used for removing the back sheet, so that EVA can be evaporated by the contact heat, thereby reducing energy loss and increasing the processing speed (see FIG. 8).

Further, when the press is brought into contact with the waste glass, the waste glass can be firmly fixed, so that it is possible to prevent the waste glass from the damage caused by the EVA evaporation shock or thermal shock. In the same way as in the previous rack, the press P must have a groove for exhaust, which can be solved by making the contact surface P1 of the press P, that is, a surface in close contact with the waste glass, have an uneven surface, i.e., a surface on which the corrugated portion P2 is formed.

Specifically, the groove formed in the corrugated portion is formed with a depth of 0.1 to 10 mm and a width of 1 to 30 mm, and it is preferable that the distance between the exhaust passages is formed with a width of 5 to 30 mm.

Further, an indirect heating method using infrared rays and a hot air blower used in the back sheet removing step M2 may be used, and in this case, it is obvious that the temperature is set to 350 to 700° C. , and a detailed description thereof will be omitted.

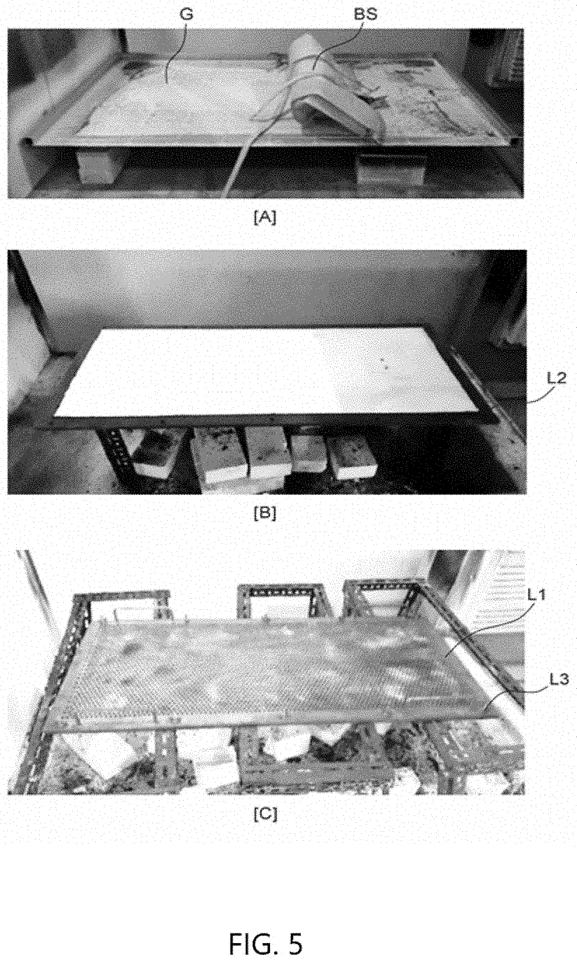

FIG. 5A is a diagram showing the process through which the back sheet is separated, and FIGS. 5B and 5C show a process of inserting waste glass into a rack in order to secondarily apply high temperature heat.

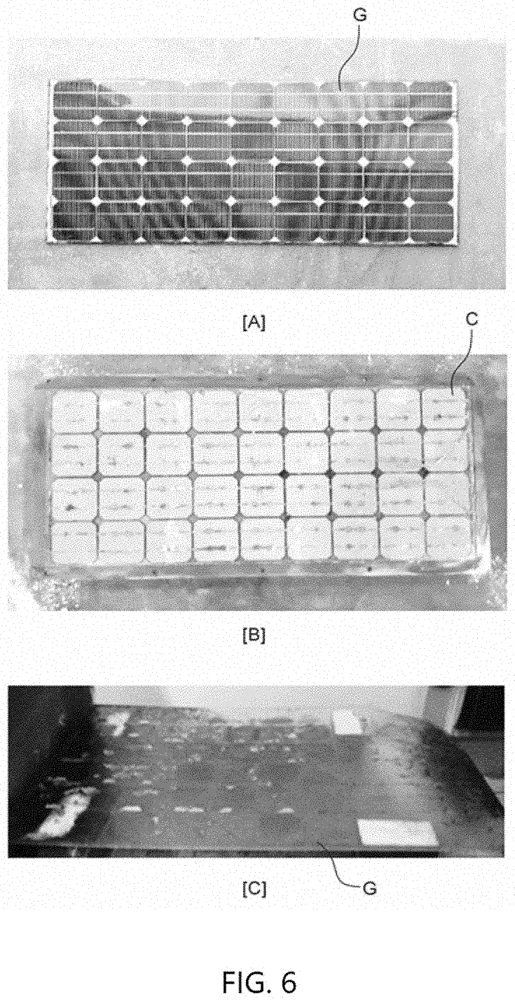

FIG. 6A is a photograph of the waste glass from which the frame has been removed before the back sheet is removed, FIG. 6B is a photograph of the waste glass from which the back sheet and EVA have been removed after the second-stage heat treatment, and FIG. 6C is a photograph of the waste glass with cells removed from the waste glass of FIG. 6B.

In addition, the solar panel waste glass recovery unit A3 is further provided with a crushing part A34, which washes with water, washes with chemicals, and then crushes the solar panel waste glass to a predetermined particle size, so that the crushed waste glass can be input into a glass bead manufacturing unit to be described later.

The automobile waste glass recovery unit A2 is configured to crush the input automobile waste glass and recover only the automobile waste glass having a predetermined particle size by removing the film separated and generated from the automobile waste glass upon crush thereof.

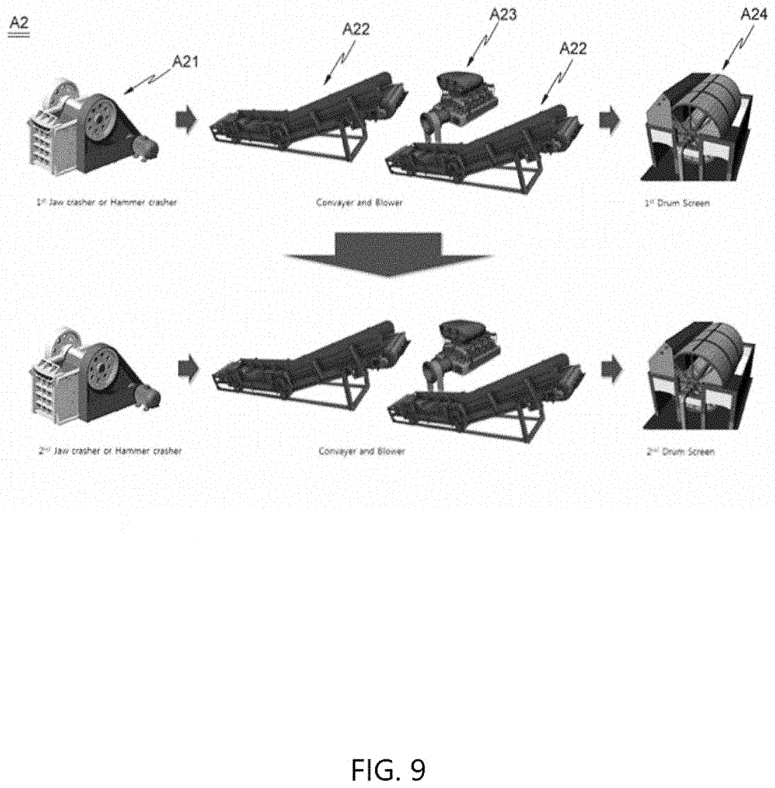

As shown in FIG. 9, the automobile waste glass recovery unit A2 includes a crushing part A21, a conveyor transporting part A22, a blower part A23, and a drum screen partt A24.

First, the crushing part A21 is used in an automobile waste glass crushing step of physically applying pressure toward the input automobile waste glass to crush it.

The crushing part A21 is formed with a general jaw crusher or a hammer crusher, and repeatedly crushes the inputted automobile waste glass.

The conveyor transporting part A22 is configured to move the automobile waste glass crushed by the crushing part A21 along the recovery path, and is arranged to be inclined upward (step of transferring the crushed waste glass upward).

Preferably, a pair of or more conveyor transporting parts A22 may be arranged spaced apart from each other with a height difference between adjacent conveyor transporting parts.

And the blower part A23 is arranged on the conveyor transporting part A22, more specifically, in the space between the spaced pair of conveyor transporting parts A22, and delivers strong wind toward the falling automobile waste glass, causing the PVB (Polyvinyl Butyral) film, which has been separated from the automobile waste glass during the process of crushing through the crushing part, to be blown away by the strong wind and allowing the automobile waste glass to fall down due to its own weight, thereby first separating the automobile waste glass (first selecting step).

In addition, the drum screen part A24 is disposed at the end of the pair of conveyor transporting parts, and is configured to separate through rotation for the second time the PVB film remaining in the automobile waste glass that has been subjected to the first selecting step through the blower part. At this time, the separated PVB film may be collected in a separate box or hopper.

In order to improve the separation performance for the PVB film, more than one automobile waste glass recovery unit may be provided, so that each process can be repeated multiple times. It is noted that such configuration is not intended to limit the scope of the present disclosure.

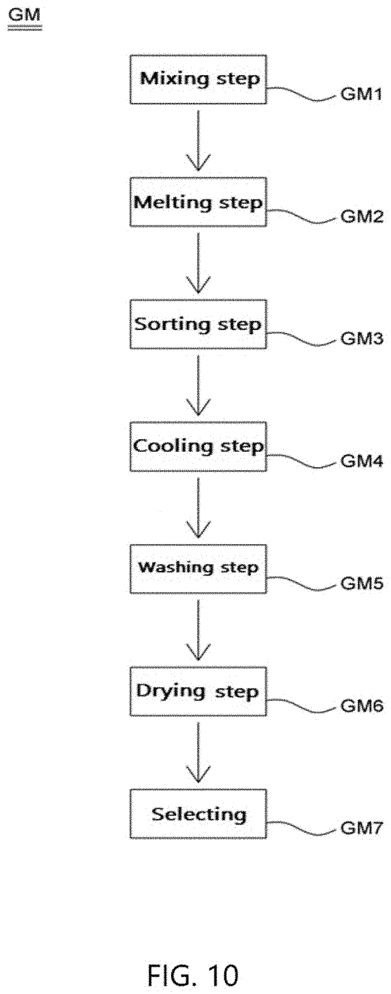

The cullet recovery unit, the automobile waste glass recovery unit, and the solar panel waste glass recovery unit according to the present example recover cullet, automobile waste glass, and solar panel waste glass having the same predetermined particle size through different paths from each other, and then cause them to be collected in a glass bead manufacturing unit for manufacturing glass bead, in which they are subjected to the following processes (See, FIG. 10).

The glass bead manufacturing process GM is carried out by the glass bead manufacturing unit, and generally includes a mixing step GM1, a melting step GM2, a sorting step GM3, a cooling step GM4, a washing step GMS, and a drying step GM6 and a selecting step GM7.

Here, it is preferable that the particle size of the waste glass input to the glass bead manufacturing unit, that is, the cullet, the automobile waste glass, and the solar panel waste glass processed through a plurality of processes, is preset to 0.3 to 2 mm.

The size may be determined under the consideration that the KS (Korean standard) particle size standard for glass beads designated by the government is determined based on the percentage remaining in each sieve using 850 um, 600 um, 300 um, or 106 um sieve for subparagraph 1-1 of KS L 2521: 2017, or 600 um, 300 um, or 150 um sieve for subparagraph 2-1. In order to stably produce glass beads of the corresponding size, they need to be crushed to have a size greater than the corresponding size during the crushing process. This is because stable production is possible in the manufacturing process of glass beads after sieving at a later stage, and glass beads having an even distribution of particle sizes can be produced.

After the cullet, the automobile waste glass, and the solar panel waste glass having the predetermined particle size are collected together in such a way by the glass beads manufacturing unit, impurities are removed from each crushed waste glass through processes such as water washing, chemical washing (using Toluen, MEK, DMC, etc.) and the like. Then, glass beads are manufactured at once through the next melting process and blowing/cooling process.

More specifically, the waste glass from which impurities have been removed is mixed through the mixing step, and the mixed waste glass is moved along the recovery path and put into a furnace in which the crushed waste glass is melted by heat and becomes beads (melting step).

The beads formed by the melting step are sorted through a vibrating feeder, and the sorted beads are subjected to the cooling step in which they are cooled by a cooling jacket or the like in a blower/reactor cooling part.

In other words, the beads could be formed to have a circular shape while swimming inside the reactor, but if they are not cooled rapidly or are transferred to a storage warehouse without removing latent heat therefrom, glass beads tend to collide and stick with each other, be crushed, or pressed down by weight, which in turn, may result in defective products. In order to solve this problem, it is necessary to provide a cooling jacket or use a cooling spiral in the reactor cooling unit.

Additionally, in this embodiment, in order to increase the cooling efficiency in the blowing/cooling step and to reduce the amount of power used in the blower, the reactor cooling unit may be provided with a water-cooled cooling unit, more specifically, a water-cooled jacket in which groundwater is circulated, or to which a water supply connected with an external cooling tower is connected. Such configuration can allow beads whose surface is molten to be rapidly changed into a spherical shape and cooled, thereby lowering the defect rate of the glass beads and minimizing the cooling cost.

In addition, by providing a thermoelectric element on the surface of the reactor cooling part with the cooling side facing in and heating side facing out, and by forming irregularities on the surface of the reactor, it is possible to maximize cooling efficiency, which in turn, can efficiently reduce power costs and water supply costs for cooling.

When the cooling step is completed as described above, beads are washed again to remove impurities from their surfaces, are subjected to the drying step for drying the remaining water after the washing, and then to a sorting process of sorting out defective products.

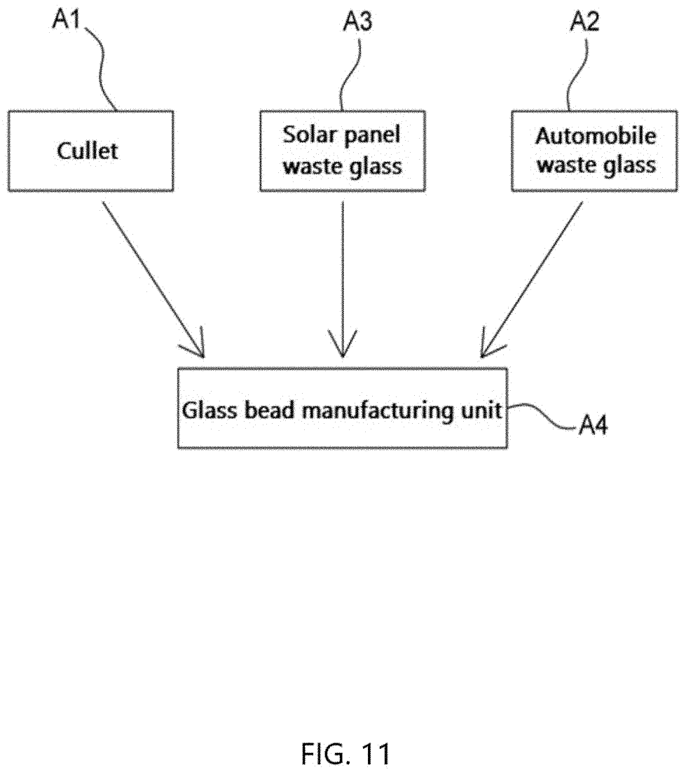

According to the present disclosure, the cullet, the automobile waste glass, and the solar panel waste glass are respectively recovered through a plurality of processes as described above, and the glass beads for road markings are manufactured using the recovered waste glass (see FIG. 11). Therefore, glass beads can be manufactured in a state in which the sealing agent (EVA), polysilicon and the like as well as PVB film are reliably separated and removed through heat treatment, without emitting Lead (Pb), arsenic (As) and antimony (Sb). It is also possible to effectively satisfy the appearance, particle size, and performance (refractive index and retroreflective performance) of the glass beads that correspond to the manufacturing standard values of the glass beads for road markings.

TABLE 2

| | | | | |
|---|---|---|---|---|
| Sample | | | Test analysis | Test analysis |
| name | Test analysis item | Reference value | result | method |

Manufacturing test report of glass bead for road markings made of auto mobile waste glass

| | | | | |
|---|---|---|---|---|
| Automobile | Appearance | 20% or less | 24 | KS L |
| glass | (Defective rate %) | | | 2521:2017 |
| | Glass bead | First class: | 1.50 or higher | |
| | performance | Refractive index | and less than 1.64 | |
| | (Drying state) | of 1.50 or higher | | |
| | | and less than 1.64 | | |
| | | Retroreflective | 0.7 | |
| | | performance | | |
| | Water resistance | No surface blur of | No | |
| | | glass beads | | |
| | | 1/100N HCl | 1.0 | |
| | | consumption: 10 | | |
| | | ml or less | | |

Manufacturing test report of glass bead for road markings made of solar panel waste glass

| | | | | |
|---|---|---|---|---|
| Solar | Appearance | 20% or less | 17 | KS L |
| panel glass | (Defective rate %) | | | 2521:2017 |
| | Glass bead | First class: | 1.50 or higher | |
| | performance | Refractive index | and less than 1.64 | |
| | (Drying state) | of 1.50 or higher | | |
| | | and less than 1.64 | | |
| | | Retroreflective | 0.9 | |
| | | performance | | |
| | Water resistance | No surface blur of | No | |
| | | glass beads | | |
| | | 1/100N HCl | 0.8 | |
| | | Consumption: 10 | | |
| | | ml or less | | |

Furthermore, in order to manufacture glass beads for road markings, by allowing the automobile waste glass, the solar panel waste glass, and general cullet (window, industrial glass, etc.) to be crushed, separated and recovered with a particle size of 0.3 to 2 mm through different processes, respectively, it is possible to minimize the defect rate in the manufacture of glass beads for road markings, and exhibit the refractive index and retroreflective performance which meet the standard values.

Additionally, according to the present disclosure, as described above, when crushing the waste automobile glass, the blower and the plurality of conveyors with height difference therebewteen are installed to improve separation performance of PVB films and the like, and EVA and polysilicon are reliably separated and removed by two heat treatments through the low and high temperatures when crushing solar panel waste glass. Therefore, Lead (Pb), arsenic (As), and antimony (Sb) can be prevented from being detected when manufacturing glass beads for road markings using automobile waste glass and solar panel waste glass.

Further, FIGS. 12A and 12B show a modified example according to the present disclosure.

Fixed connection between the top rack L1 and the connecting bar L3, and fixed connection between the bottom rack L2 and the connecting bar may be easily and releasably made by the fixing block unit B.

At this time, a first block B1 and a second block B2 of the fixing block unit B are coupled to each other, and in a case where the top rack L1 and connecting bar L3 are combined, the first block B1 is provided on the top rack L1 and the second block B2 is provided on the connecting bar L3, while, in a case where the connecting bar L3 and the bottom rack L2 are combined, the first block B1 is provided on the connecting bar L3 and the second block B2 is provided on the bottom rack L2.

More preferably, after fixing the connecting bar L3 to the bottom rack L2 via welding, etc., the top rack L1 may be coupled to the connecting bar L3 through the fixing block unit B. Hereinafter, the fixing block unit will be described based on this example.

As shown in FIG. 12A, the fixing block unit B includes the first block B1 provided on the top rack L1, the second block B2 provided in the connecting bar L3 and having an inlet hole B21 through which the first block B1 is inserted, a pair of fixing arms B14 provided in the first block B1 and protruding and fixed to fitting grooves B22 formed in the inlet hole B21, and an elevating rod B13 that elevates and descends inside the first block B1 to limit retraction of the pair of fixing arms B14.

With this configuration, when the first block B1 is inserted into the inlet hole B21, and the elevating rod B13 descends causing the pair of fixing arms B14 to protrude to both sides, the fixing arms B14 are inserted into the fitting grooves B22 to fix the first block B1 to the second block B2.

The descended elevating rod B13 is located between the pair of fixing arms B14, and prevents the fixing arms B14 from being retracted, so that the first block B1 and the second block B2 are maintained in the fixed state.

Under the first block B1 is disposed a return member B16 which can be in close contact with the bottom surface of the elevating rod B13 and includes a return spring B163.

When the return member B16 strikes the bottom surface of the elevating rod B13 by the elastic force of the return spring B163 to push up the lifting rod B13, the retraction of the fixing arms B14 is allowed, so that the first block B1 can be separated from the second block B2.

Each configuration will be described in more detail with reference to FIGS. 12A and 12B. [A] of FIG. 12A shows a schematic view representing how the fixing block unit B is installed, and [B] and [C] of FIG. 12A, [D], [E] and [F] of FIG. 12B show operations of combining the first block B1 to the second block B2 in order. For simplifying drawings, reference numerals are shown only in FIG. 12A, and reference numerals for the same configuration in the remaining drawings will be the same as shown in FIG. 12A.

First, the second block B2 will be described. As shown in [A] and [B] of FIG. 12A, it is protrudingly coupled to one side of the connecting bar L3, and provided with the inlet hole B21 formed therein to be open up and down, and fitting grooves B22 formed on both sides of the inlet hole B21, into which that the fixing arms B14 to be described later can be inserted, respectively.

Inside the first block B1 formed in a longitudinal direction thereof is a moving space part B11 through which the elevating rod B13 to be described later can move up and down. An elevating space part B126 having a larger space than the moving space part B11 is formed at the top of the moving space part B11 to communicate with the moving space part B11.

In addition, although not shown in the drawing, it is preferable that the first block B1 is composed of two portions, i.e., a top portion and a bottom portion for allowing the aforementioned components to be assembled therein. But such configuration is not intended to limit the scope of the present disclosure.

The moving space part B11 is a space in which the elevating rod B13 ascends and descends, and the elevating space part B126 is a space in which a pull-up member B12 to be described later ascends and descends. A stopping portion B111 protruding inward to limit the elevation of the elevating rod B13 is formed at the top portion of the moving space B11, while a bottom step portion for limiting the downward movement of the return member B16 to be described later is further formed at the bottom portion of the moving space part B11.

The elevating rod B13 is made of iron that is affected by magnetism, and has a flat top part and a bottom part with an entry point B131 for opening the fixing arms B14 to be described later when the elevating rod descends. On both sides of the entry point B131 formed are gentle slope portions B132, which are more slightly inclined than the entry point B131, so that it is possible to secure a space so as not to interfere with the retracting operation of the fixing arms B14 to be described later.

Furthermore, the plurality of the fixing arms B14 are arranged so as to protrude to both sides of the first block B1, and are provided with spring support wings B141 formed on both sides of each of the fixing arms B14. A pair of second springs B143 for supporting the spring support wings B141 are provided such that, as shown in [B] of FIG. 12A, the fixing arms B14 normally protrude inside the first block B1 by elastic forces of the second springs.

Additionally, an entry guide inclined portion B142 is formed on the inner top portion of each fixing arm B14, so that the elevating rod B13 can easily enter between the fixing arms.

The pull-up member B12 is provided at the top portion of the first block B1, and the pull-up member B12 is disposed in the elevating space part B126 so as to move in a vertical direction. It includes a magnet body B121 and pull-up handles B122 provided on both sides of the magnet body B121 and protruding out of both sides of the first block B1. A first spring B123 is provided on the top portion of the magnet body B121, and applies an elastic force pushing the pull-up member B12 downward. A line coupling part B122a to which a pull-up line B124 to be described later is coupled is further formed on each pull-up handle B122.

Furthermore, for limiting the arbitrary rise of the elevating rod B13, rotation stoppers B15 are also provided, each including a stopping body B151 rotatably provided on a side of the first block B1 through a first elastic hinge B154, and a stopping leg B152 that is hinged to the stopping body B151 through a second elastic hinge part B155 and can protrude into the moving space part B11.

In this regard, the stopping leg B152 is characterized in that it is a limited rotational member capable of rotating only in a downward direction with respect to the stopping body B151.

Furthermore, there are also provided the pull-up lines B124, each connecting the second elastic hinge part B155 and the pull-up handle B122 of the pull-up member B12. Line space parts B125 are also formed inside the first block B1, so that the pull-up lines B124 can be located therein, respectively. Although not shown in the drawings, the first elastic hinge part B154 may further include a coil spring rotating the first elastic hinge part downward as shown in [B] of FIG. 12A. Such configuration is not intended to limit the scope of the present disclosure.

The return member B16 is further provided at the bottom portion of the first block B1, and the return member B16 includes a return body B161 having a pointed portion receiving groove B161a formed in the same shape as the entry point B131 so that the entry point B131 of the elevating rod B13 is inserted thereinto, a return handle B162 provided under the return body B161 and protruding below the first block B1, and a return spring B163 provided to be inserted around the return handle B162 at the bottom of the return body B161. A handle holding part B162a having a wide diameter is further provided at the bottom portion of the return handle B162 so that the user can easily hold it.

Hereinafter, the operation of the fixing block unit B having the above configuration will be described in more detail with reference to the drawings.

First, as shown in [B] of FIG. 12A, before the first block B1 and the second block B2 are coupled, the pull-up member B12 fixes the elevating rod B13 with magnetic force so that the elevating rod B13 is located at the top portion of the moving space part B11.

After that, the first block B1 is inserted into the inlet hole B21, as shown in [C] of FIG. 12A, and then the user holds the pull-up handle B122 and elevates the pull-up member B12. When the elevating rod B13 is prevented from the elevation by the stopping portion B111, the magnet body B121 and the elevating rod B13 are separated from each other. As the distance therebetween increases, the magnetic force therebetween is weakened, and the elevating rod B13 falls by its own weight.

At this time, the pull-up line B124 is pulled, and the rotation stopper B15 rotates so that the stopping leg B152 may invade the moving space part B11. However, since the stopping leg B152 can rotate in the direction shown in [C] of FIG. 12A, it does not interfere with the downward movement of the elevating rod B13.

When the lifting rod B13 falls by its own weight, the entry point B131 passes between the entry guide inclined portions B142 of the pair of fixing arms B14, and pushes the pair of fixing arms B14 to both sides of the first block B1 as shown in [D] of FIG. 12B, so that the fixing arms B14 are inserted into the fitting grooves B22 in the second block B2, respectively. The elevating rod B13 is positioned between the pair of fixing arms B14 to prevent retraction of the pair of fixing arms B14 so that the first block B1 is firmly fixed to the second block B2.

To explain this in more detail, when the elevating rod B13 falls, as shown in [D] of FIG. 12B, the return member B16 is pressed from the top to slightly descend, and then as shown in [E] of FIG. 12B, the return member B16 partially ascends due to the elastic force of the return spring B163 as the force generated from the acceleration of gravity is perished. The stopping legs B152 of the rotation stoppers B15 are in close contact with the top portion of the elevating rod B13 to prevent the elevating rod B13 from arbitrary ascent.

That is, a space in which the folded stopping leg B152 as shown in [C] of FIG. 12A is unfolded is secured through the state as shown in [D] of FIG. 12B, and it is possible to secure the fixing force by supporting the top portion of the elevating rod B13 as shown in [E] of FIG. 12B.

In order to release the first block B1 from the second block B2, the user can hold and pull the return handle B162 until the bottom end of the return body B161 of the return member B16 is brought into contact with the bottom step portion B112 as shown in [F] of FIG. 12B. Then, the elevating rod B13 also descends by its own weight. At this time, when the user releases the return member B16, it hits the elevating rod B13 upward by the elastic force of the return spring B163. Then, the elevating rod B13 ascends, and is attached to the magnet body B121 of the pull-up member B12 by the magnetic force to be located at the original position as shown in [B] of FIG. 12A. As a result, the first block B1 can be easily removed from the second block B2.

That is, the first block B1 and the second block B2 can be more easily combined, fixed, maintained, and separated with the above configuration.

While the waste glass recovery method for manufacturing a glass bead having a specific shape, structure, and configuration has been mainly described with reference to the accompanying drawings in the above description of the present invention, various modifications, changes and substitutions are possible by those skilled in the art, and such modifications, changes and substitutions should be construed as belonging to the protection scope of the present invention.

What is claimed is:

1. A method of recovering waste glass and manufacturing glass beads, the method comprising:
separating back sheet by first heating the waste glass from which a frame has been separated; and
removing sealing agent by heating for the second time the waste glass from which the frame has been separated and evaporating the sealing agent in the waste glass.

2. The method of claim 1, wherein the step of separating the back sheet includes heating the waste glass using heat set at a temperature of 100 to 250° C.

3. The method of clam 1, wherein said removing the sealing agent includes heating the waste glass using heat set at a temperature of 350 to 700° C.

4. The method of claim 3, wherein said separating the back sheet uses a direct heating method using a press equipped with a heating wire, or an indirect heating method using an infrared or a hot air blower, or mixes and uses two or more of these methods together, to apply heat to the waste glass and separate the back sheet, and
wherein said removing the sealing agent uses a direct heating method using a rack provided with a heating wire and into which the waste glass is inserted, or the press P equipped with a heating wire, or an indirect heating method using infrared or a hot air blower, or mixes and uses two or more of these methods, to apply heat to the waste glass, evaporate and remove the sealing agent.
